(19) United States
(12) Patent Application Publication
(10) Pub. No.: US 2009/0173113 A1
(43) Pub. Date: Jul. 9, 2009

(54) LATCH FOR SIGN DISPLAY MODULE

(75) Inventors: George A. Pappas, Rancho Cordova, CA (US); Jason D. Stapleton, Lodi, CA (US)

Correspondence Address: ANTOINETTE M. TEASE, P. O. BOX 51016, BILLINGS, MT, 59105, US

(73) Assignee: D3 LED, LLC, Union City, NJ (US)

(21) Appl. No.: 11/971,889

(22) Filed: Jan. 9, 2008

(51) Int. Cl. E05B 65/44; F16J 15/00

(52) U.S. Cl. 70/83; 277/628

(57) ABSTRACT

A latch for attaching a display module to a face panel, the latch comprising: a front panel; rear panel; latch arm; circular extension; and circular rotating cuff; wherein the top and bottom portions of the rear panel are fixedly attached to the front panel; the latch arm is situated in between the front panel and the middle portion of the rear panel; the circular extension extends perpendicularly from the front panel and is fixedly attached to the latch arm; the circular rotating cuff is located in a cut-out in the middle portion of the rear panel and is fixedly attached to the latch arm; the circular extension and circular rotating cuff each comprises a wrench hole; the wrench holes in the circular extension and circular rotating cuff do not extend all the way through the latch; and the circular extension comprises one or more O-rings.

### BACKGROUND OF THE INVENTION

1. Field of the Invention.

The present invention relates generally to the field of latches, and more specifically, to a latch designed to keep water and other forms of precipitation from entering an LED sign display module.

2. Description of the Related Art.

Most large light-emitting diode (LED) signs are comprised of a number of individual display modules. The number of display modules in a large LED sign, such as those found in Times Square in New York City, can be in the dozens or even hundreds. Each display module is attached to a face panel, which in turn is attached to a large metal frame. The modules are attached to the face panel with latches, and there are usually four latches per module. The frame of the LED sign is typically housed in a water-resistant cabinet. This cabinet is preferably large enough to allow a person to enter the cabinet for purposes of conducting maintenance or repair on the LED sign.

Each individual display module in the LED sign comprises a primary printed circuit board (PCB) and an auxiliary PCB. The LEDs themselves are typically part of the primary PCB. The individual display modules also have fan assemblies that house the data connections, power supply and fans for each display module. It is important to keep water away from the PCBs and the fan assemblies to avoid causing damage to the LED signs. For this reason, several precautions are taken to keep water and other forms of precipitation away from the LED signs.

First, as noted above, the LED signs themselves are housed in a water-resistant cabinet. Second, each individual display module has a splash cover that is situated on top of the fan assembly and a drip cover that lies above the splash cover. Third, rubber gaskets are used between the fan assembly and the chassis (or frame) of each individual display module and also between the chassis and the face panel of the large metal frame that houses the display modules. Fourth, silicone rubber “potting” is poured and then cured around all of the LEDs on the front face of the primary PCB to prevent water from contacting the front face of the primary PCB.

Despite these precautions, water can travel from the front of an individual display module to the rear of the module through latch holes that, in prior art, extend clear from the front of the module through to the rear. Typically, these latch holes would be plugged with rubber stoppers, but these stoppers are easy to lose and difficult to install and remove, which often means they are not used at all. As explained more fully below, the present invention is designed to overcome this deficiency in prior art latches by providing a latch that eliminates the need for a rubber plug or stopper while still providing the same front-and-back access afforded by the prior art latches.

### BRIEF SUMMARY OF THE INVENTION

The present invention is a latch for attaching a display module to a face panel, the latch comprising: a front panel; a rear panel; a latch arm; a circular extension; and a circular rotating cuff; wherein the rear panel is comprises a top portion and a bottom portion, and wherein the top and bottom portions of the rear panel are fixedly attached to the front panel; wherein the rear panel further comprises a middle portion, and wherein the latch arm is situated in between the front panel and the middle portion of the rear panel; wherein the circular extension extends perpendicularly from the front panel and is fixedly attached to the latch arm through a cut-out in the front panel; wherein the circular rotating cuff is located in a cut-out in the middle portion of the rear panel and is fixedly attached to the latch arm; wherein the circular extension and circular rotating cuff each comprises a wrench hole; wherein when a wrench is inserted into the wrench hole, the latch arm can be rotated ninety degrees to the left or ninety degrees to the right from a fully retracted position; wherein the latch comprises a right side and a left side, and the right and left sides of the latch each comprises a latch stop that prevents the latch arm from extending greater than ninety degrees from a fully retracted position; wherein when the latch arm is in a fully retracted position, it is situated completely between the front panel and the middle portion of the rear panel; wherein the wrench hole in the circular extension does not extend all the way through the latch; wherein the wrench hole in the circular rotating cuff does not extend all the way through the latch; wherein the wrench hole in the circular extension and the wrench hole in the circular rotating cuff are aligned laterally; and wherein the circular extension comprises one or more O-rings.

In a preferred embodiment, the latch is installed on a chassis of a display module, wherein the chassis comprises a front face, a rear face, and a latch hole; wherein the latch hole extends from the front face to the rear face of the chassis; wherein the circular extension is inserted into the latch hole from the rear face of the chassis; and wherein the O-rings on the circular extension prevent water from traveling through the latch hole from the front to the rear of the display module.

In a preferred embodiment, when the display module is installed on a face panel and the latch arm extended, the face panel is situated between the latch arm and the chassis. Preferably, a rubber gasket is situated between the chassis and the face panel, wherein the rubber gasket comprises compressible lips, and wherein when the latch arm is extended, it draws the chassis in to the face panel, thereby compressing the lips on the rubber gasket. The latch arm preferably comprises beveled edges, wherein the beveled edges serve to draw the chassis in to the face panel when the latch arm is extended.

In a preferred embodiment, the circular extension comprises a distal end, wherein the circular extension is roughly ⅞-inch long from the front panel to the distal end of the circular extension, wherein the circular extension comprises a diameter, and wherein the diameter of the circular extension is roughly 0.5-inch. Preferably, the circular rotating cuff is of roughly the same diameter as the circular extension. The circular rotating cuff preferably comprises cut-outs to reduce the weight of the latch and save material.

In a preferred embodiment, the front and rear panels each comprises at least two screw holes for attaching the latch to a chassis of a display module.

### BRIEF DESCRIPTION OF THE DRAWINGS

FIG. 1 is a rear view of a large display panel comprised of several LED modules.

FIG. 2 is a rear view of an individual display module with the splash cover and fan assembly removed.

FIG. 2A is a detail view of the lips on the rubber gasket.

FIG. 3 is a rear view of an individual display module with the splash cover, fan assembly, first and second rubber gaskets and auxiliary PCB removed.

FIG. 4 is a partial perspective view of the bottom right-hand corner of an individual display module showing where the latch of the present invention would attach to the rear of the chassis.

FIG. 5 is a front perspective view of the chassis of an individual display module.

FIG. 6 is a front view of the bottom left-hand corner of the chassis of an individual display module showing where the latch shown in FIG. 4 would attach.

FIG. 7 is an exploded view of the visor, primary PCB and chassis of an individual display module. This figure also shows the latch holes on the visor and primary PCB and the visor mounting holes on the primary PCB.

FIG. 8 is a rear perspective view of the visor of an individual display module showing the visor mounting extensions on the rear of the visor.

FIG. 9 is a section view of latch of the present invention and the area on an individual display module where the latch would attach. In this figure, for illustrative purposes, the latch, visor and primary PCB are shown not installed on the chassis.

FIG. 10 is a section view of the latch of the present invention installed on the chassis of an individual display module. In this figure, the latch, visor and primary PCB are all installed on the chassis.

FIG. 11 is a first perspective view of the latch of the present invention with the latch arm extended.

FIG. 12 is a second perspective view of the latch of the present invention with the latch arm extended.

FIG. 13 is a third perspective view of the latch of the present invention with the latch arm extended.

FIG. 14 is a perspective view of the latch of the present invention with the latch arm retracted.

FIG. 15 is a perspective view of the latch of the present invention shown with a hex wrench accessing the latch from what would be the front face of an individual display module.

FIG. 16 is a perspective view of a prior art latch shown with a hex wrench accessing the latch from what would be the front face of an individual display module.

FIG. 17 is a perspective view of a prior art latch shown from the side of the latch that would attach to the chassis.

FIG. 18 is a perspective view of a rubber stopper or plug used with the prior art latch.

FIG. 19 is a front view of the latch of the present invention. The front face of the latch is adjacent to the chassis of the display module when the latch is installed.

FIG. 20 is a side view of the latch of the present invention.

FIG. 21 is a rear view of the latch of the present invention.

FIG. 22 is a section view of the latch of the present invention, shown with a hex wrench inserted into the wrench hole of the latch.

FIG. 23 is a section view of a prior art latch, shown with a hex wrench inserted into the wrench hole of the latch.

### REFERENCE NUMBERS

1 LED sign
2 Display module
3 Chassis
4 Fan assembly
5 Splash cover
6 Drain shield
7 Face panel
8 Latch
9 Latch arm
10 First rubber gasket
11 Compressible lips
12 Second rubber gasket
13 Auxiliary PCB
14 Primary PCB
15 Screw
16 Screw hole
17 Circular extension
18 Latch hole
19 Visor
20 Horizontal ridge
21 LED
22 LED hole
23 Visor mounting extension
24 Visor mounting hole
25 Visor mounting receiver
26 Silicone rubber potting
27 Beveled edge
28 Front panel (of latch)
29 O-ring
30 Wrench hole
31 Latch arm stop
32 Rear panel (of latch)
33 Top portion
34 Bottom portion
35 Circular rotating cuff
36 Cut-out
37 Hex wrench
38 Rubber plug

### DETAILED DESCRIPTION OF INVENTION

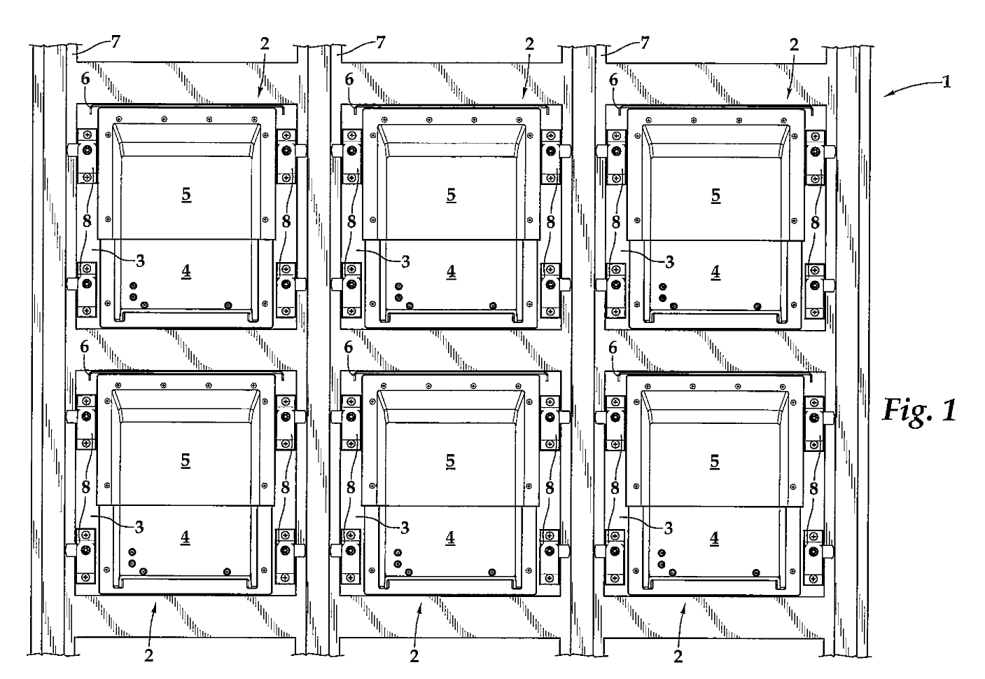

FIG. 1 is a rear view of a large display panel comprised of several LED modules. As shown in this figure, an LED sign 1 comprises a number of individual display modules 2. Although FIG. 1 shows an LED sign comprised of six individual display modules, a large LED sign could have dozens or even hundreds of individual display modules.

Each display module 2 comprises a chassis 3, a fan assembly 4 and a splash cover 5. The fan assembly 4 houses the data connections, power supply and fans for each module, and the splash cover 5 prevents water, debris, grit, dust or other matter from entering the fan assembly 4. The splash cover 5 preferably sits directly beneath a drip shield 6 that extends across the top of the module.

The display modules are held in place on a face panel 7 by latches 8. Each display module 2 preferably comprises four latches 8. The latches are situated as shown in FIG. 1, with two vertically aligned latches on the right-hand side of the module and two vertically aligned modules on the left-hand side of the module.

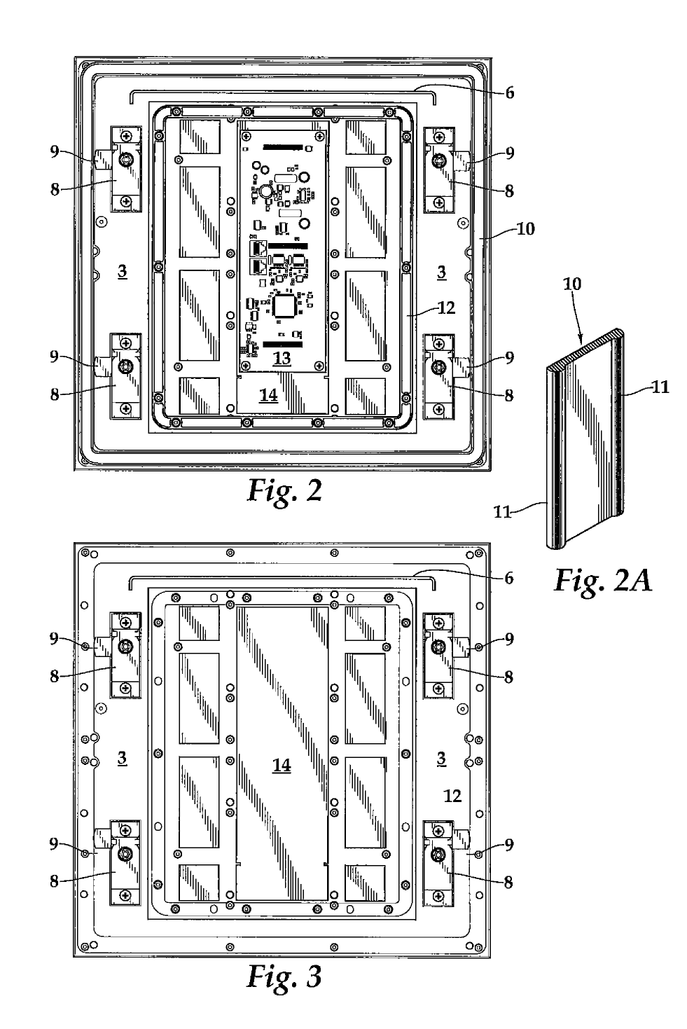

FIG. 2 is a rear view of an individual display module with the splash cover and fan assembly removed. The face panel 7 is not shown in this figure, but the face panel 7 would ordinarily lie between the latch arm 9 and the chassis 3. As shown in this figure, a first rubber gasket 10 lies between the chassis 3 and the face panel 7 on each module 2. The first rubber gasket 10 preferably comprises compressible lips 11 that run along either side of the gasket. These lips allow the gasket to be compressed against the face panel when the module is installed on the face panel by extending the arms on the latches, thereby creating a tighter seal. A second rubber gasket 12 preferably lies between the chassis 3 and the fan assembly 4. The second rubber gasket 12 preferably comprises compressible lips 11 as well.

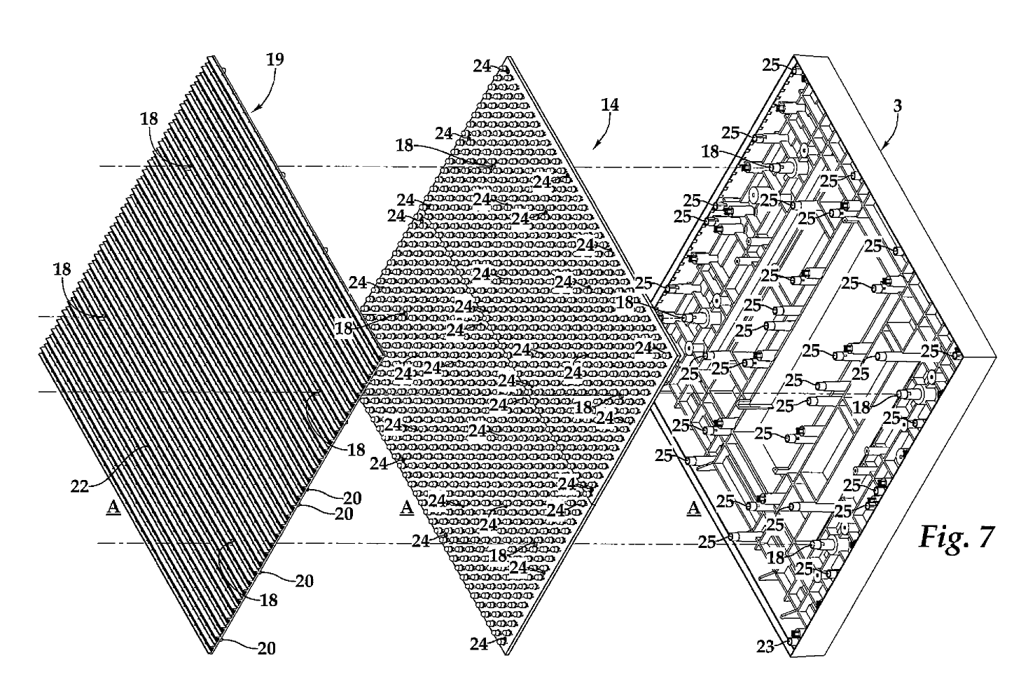

This figure also shows the auxiliary PCB 13, which is attached to the back of the primary PCB 14. As shown in FIG. 7, the primary PCB contains the LEDs that form the LED sign.

FIG. 3 is a rear view of an individual display module with the splash cover, fan assembly, first and second rubber gaskets and auxiliary PCB removed. The face panel 7 is not shown in this figure either.

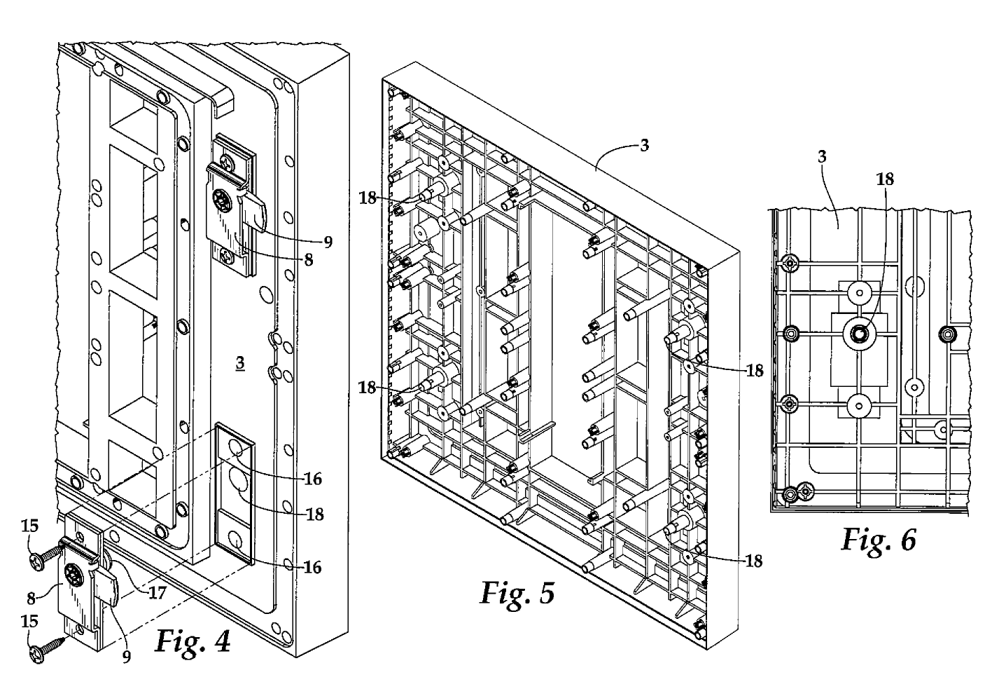

FIG. 4 is a partial perspective view of the bottom right-hand corner of an individual display module showing where the latch of the present invention would attach to the rear of the chassis. As shown in FIG. 1, each display module comprises four latches 8. These latches are situated in the top-right, bottom-right, top-left and bottom-left of each module. In the present invention, identical latches can be used in each of these locations because the latch arms 9 swing in either direction (right or left).

Each latch attaches to the chassis 3 with two screws 15. These screws are inserted into screw holes 16 on the chassis 3. As shown more clearly in subsequent figures, the latch of the present invention comprises a circular extension 17 that protrudes from the front of the latch and is inserted into a latch hole 18 in the chassis 3.

FIG. 5 is a front perspective view of the chassis of an individual display module. This is the reverse side of the chassis shown in FIG. 4. FIG. 6 is a front view of the bottom left-hand corner of the chassis of an individual display module showing where the latch shown in FIG. 4 would attach. The screw holes 16 (shown in FIG. 4) do not extend all the way through to the front of the chassis 3; however, the latch hole 18 does extend all the way through the chassis 3.

FIG. 7 is an exploded view of the visor, primary PCB and chassis of an individual display module. This figure also shows the latch holes on the visor and primary PCB and the visor mounting holes on the primary PCB. The visor 19 forms the front face of each display module. The visor 19 comprises horizontal ridges 20 that extend across the width of the visor 19. (What would be the bottom edge of the visor is indicated with an “A” on FIG. 7.) The primary PCB 14 extend through LED holes 22 in the visor 19, and the horizontal ridges 20 serve to prevent overhead sunlight from reflecting off of the LEDs 21.

Both the visor 19 and the primary PCB 14 comprise latch holes 18. These latch holes 18 correspond to the latch holes on the chassis 3. As shown in FIG. 4, the latch holes 18 can be accessed from the rear of the module, and as shown in FIG. 7, they can also be accessed from the front of the module through the visor 19.

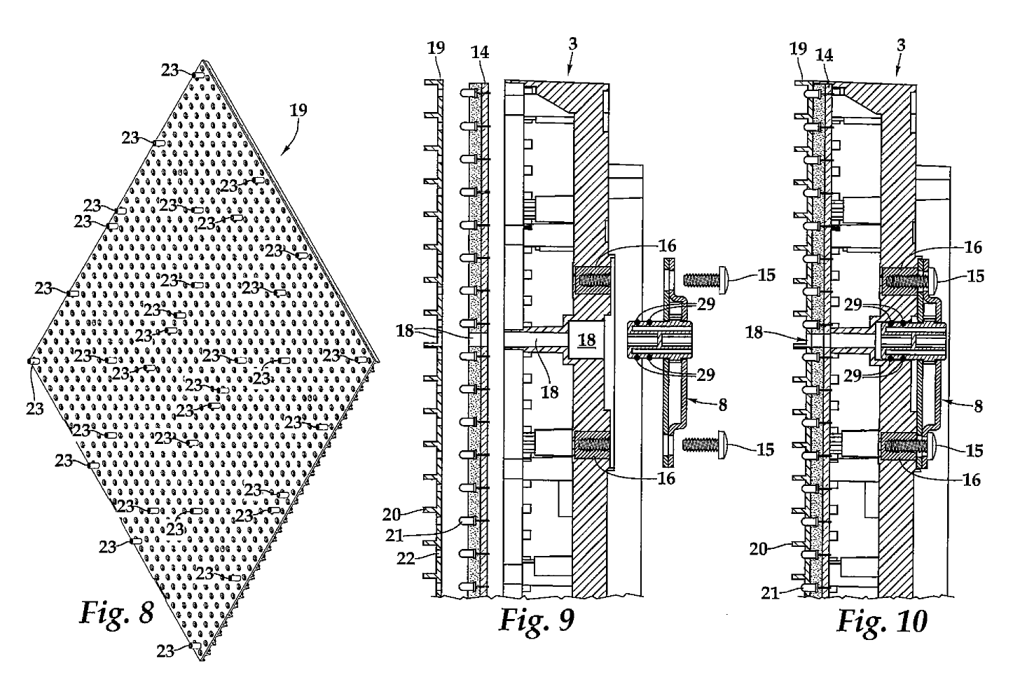

FIG. 8 is a rear perspective view of the visor of an individual display module showing the visor mounting extensions on the rear of the visor. The visor mounting extensions 23 on the rear face of the visor 19 extend through the visor mounting holes 24 shown in the primary PCB 14 in FIG. 7 and into visor mounting receivers 25 in the chassis 3 (see FIG. 7). The visor 19 is secured in place with self-tapping screws that are inserted from the rear of the chassis 3 (the rear of the chassis is the side shown in FIG. 4).

FIG. 9 is a section view of latch of the present invention and the area on an individual display module where the latch would attach. In this figure, for illustrative purposes, the latch, visor and primary PCB are shown not installed on the chassis (though technically the primary PCB would be installed before the potting were poured). This figure shows the silicone rubber potting 26 that is poured and then cured around the LEDs 21 after the primary PCB 14 is installed.

FIG. 10 is a section view of the latch of the present invention installed on the chassis of an individual display module. In this figure, the latch, visor and PCB are all installed on the chassis. As shown in this figure, the latch holes 18 clearly extend from the rear of the chassis 3 through the primary PCB 14 and visor 19 to the front of the module.

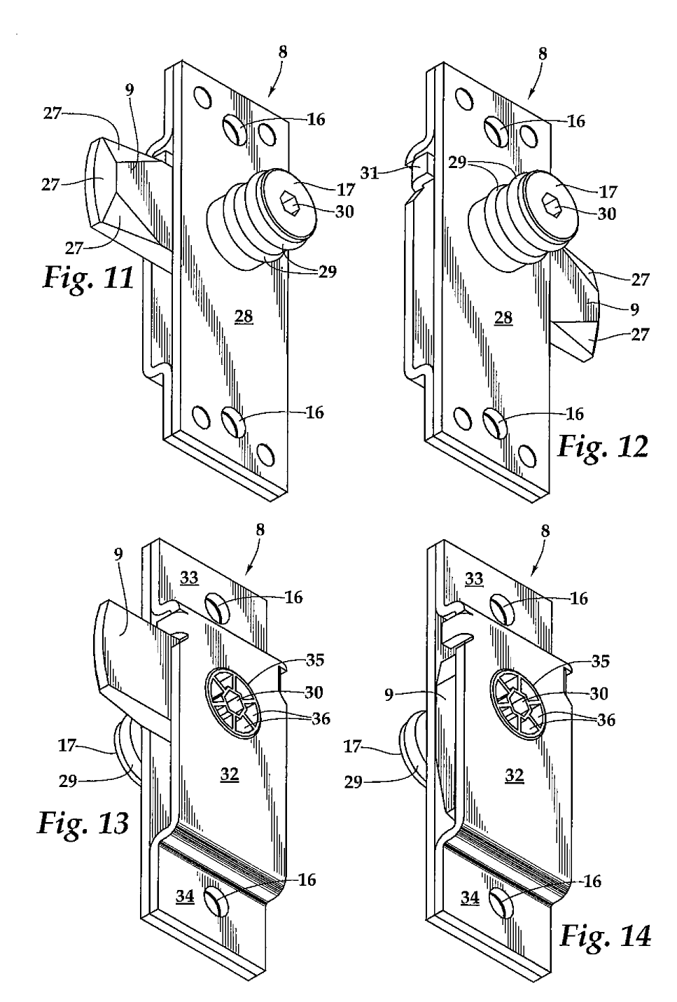

FIG. 11 is a first perspective view of the latch of the present invention with the latch arm extended. As shown in this figure, the latch arm 9 preferably comprises beveled edges 27. These beveled edges 27 serve to catch the face panel 7 (see FIG. 1) and then draw the chassis 3 closer to the face panel 7, thereby compressing the lips 11 on the first rubber gasket 10, to create a tight seal.

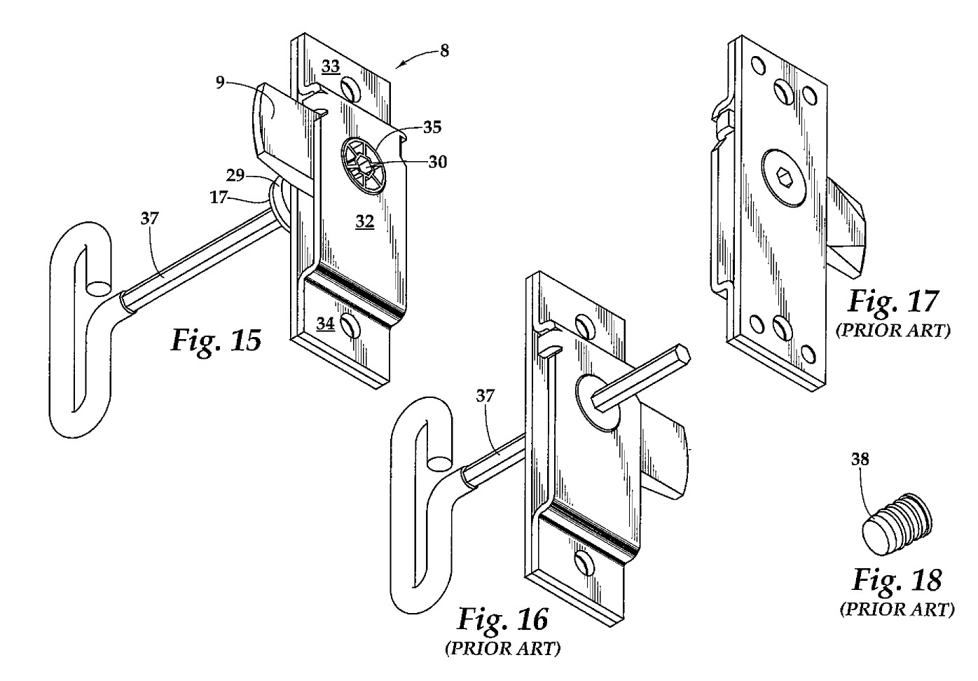

The latch 8 also comprises a circular extension 17, first mentioned in connection with FIG. 4, that is inserted into the latch hole 18 from the rear of the chassis 3 when the latch is installed (see FIGS. 4 and 9-10). The circular extension 17 is preferably 718-inch long (measured from the front panel 28 of the latch to the distal end of the circular extension 17, which is the end farthest from the front panel 28) and approximately 0.5-inch wide. The circular extension 17 preferably comprises two O-rings 29, which create a seal when the circular extension 17 is inserted into the latch hole 18 (see also FIG. 10). The O-rings 29 prevent water from entering the latch hole 18 from the front of the sign and traveling clear through to the back of the sign. The circular extension 17 further comprises a wrench hole 30 into which a hex wrench can be inserted to turn the latch arm 9 (see FIG. 15). As noted above, the latch arm 9 can be turned in either direction (left or right).

FIG. 12 is a second perspective view of the latch of the present invention with the latch arm extended. This figure shows the latch arm stop 31 that prevents the latch arm 9 from rotating further than one hundred eighty degrees (180°) (from the position shown in FIG. 11 to the position shown in FIG. 12) or more than ninety degrees (90°) from a fully retracted position.

FIG. 13 is a third perspective view of the latch of the present invention with the latch arm extended. As shown in this figure, the latch comprises a rear panel 32 that houses the latch arm 9 when it is retracted. The rear panel 32 curves downward on both the top and bottom ends to form top 33 and bottom 34 portions that lie directly adjacent to the front panel 28. The top 33 and bottom 34 portions of the rear panel 32 are physically affixed to the front panel 28 in any suitable manner (for example they can be bolted or welded). The remainder of the rear panel 32 forms a middle portion, and the latch arm 9 is situated in between the front panel 28 and the middle portion of the rear panel 32. The front 28 and rear 32 panels each comprises a screw hole 16 on either end for fastening the latch 8 to the chassis 3, as shown in FIG. 4.

On the rear side of the latch (shown in FIG. 13) is a circular rotating cuff 35 of roughly the same diameter as the circular extension 17 on the other (front) side of the latch (see FIGS. 11 and 12). The circular rotating cuff 35 is located in a cut-out in the rear panel 32 and is preferably flush or nearly flush with the rear panel. The circular rotating cuff 35 is shown here with optional cut-outs 36 to reduce the weight of the latch and save material. The wrench hole 30 in the middle of the circular rotating cuff 35 allows the latch arm 9 to be rotated in either direction from the rear of the module when the latch is installed on the chassis 3. The latch arm 9 is fixedly attached to both the circular extension 17 and the circular rotating cuff 35, so that the latch arm 9, circular extension 17 and circular rotating cuff 35 all rotate together.

FIG. 14 is a perspective view of the latch of the present invention with the latch arm retracted. In this case, the latch arm 9 would be retracted either by inserting a hex wrench into the circular extension 17 and rotating it in a clockwise direction (from the perspective shown in FIG. 12) or by inserting a hex wrench into the circular rotating cuff 35 and rotating it in a counter-clockwise direction (from the perspective shown in FIG. 13).

FIG. 15 is a perspective view of the latch of the present invention shown with a hex wrench accessing the latch from what would be the front face of an individual display module. In this case, the hex wrench would extend through the latch hole 18 in the visor 19, through the latch hole 18 in the primary PCB 14, through the latch hole 18 in the chassis 3 and into the wrench hole 30 in the circular extension 17 of the latch 8 (see FIG. 7). As illustrated in detail in FIG. 22, the wrench hole 30 in the circular extension 17 does not extend all the way through the latch, nor does the wrench hole 30 in the circular rotating cuff 35. In this manner, water is prevented from traveling from the front to the back of the module via the latch hole. (It is the fact that the wrench hole 30 does not extend all the way through the latch, together with the fact that the circular extension 17 comprises O-rings 29, that prevents water from traveling through the latch hole 18 from the front of the module to the rear of the module.)

FIG. 16 is a perspective view of a prior art latch shown with a hex wrench accessing the latch from what would be the front face of an individual display module. As shown in this figure, the wrench hole 30 extends all the way through the latch in the prior art design, and there is no circular extension 17 as there is in the latch design of the present invention. FIG. 17 is a perspective view of a prior art latch shown from the side of the latch that would attach to the chassis. Rather than a circular extension, the prior art latches used a separate rubber plug 38 (see FIG. 18) that would be inserted into the latch hole from the front of the module (through the visor). As noted above, these plugs are difficult to insert and remove and easy to use, and more often than not, they are not used at all. When the plugs are not used, water can freely travel from the front of the module through to the back of the module via the latch holes. The present invention overcomes this limitation by providing a circular extension 17 on the latch itself, thereby eliminating the need for the rubber plugs.

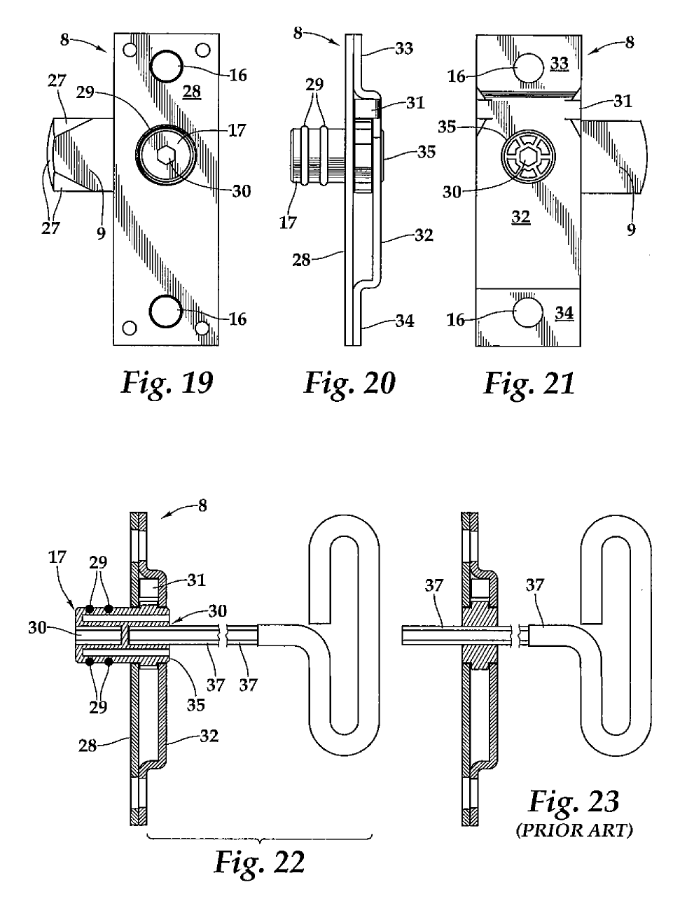

FIG. 19 is a front view of the latch of the present invention. The front face of the latch is adjacent to the chassis of the display module when the latch is installed. FIG. 20 is a side view of the latch of the present invention. FIG. 21 is a rear view of the latch of the present invention.

FIG. 22 is a section view of the latch of the present invention, shown with a hex wrench inserted into the wrench hole. As illustrated in this figure, there is a wrench hole 30 on either side of the latch 8, but the wrench hole 30 does not extend all of the way through the latch. As shown here, the wrench holes in the circular extension 17 and circular rotating cuff 35 are aligned laterally.

FIG. 23 is a section view of a prior art latch, shown with a hex wrench inserted into the wrench hole. As illustrated in this figure, the wrench hole extends all of the way through the latch. This design is faulty in that it allows water to travel from the front to the back of the module unless a separate rubber plug 38 is used to plug the latch hole 18 in the visor 19.

Although the above discussion relates primarily to an LED sign module, the present invention can be used with any other sign module in which it is desirable to keep water and other forms of precipitation from entering the sign module. Furthermore, although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A latch for attaching a display module to a face panel, the latch comprising:
(a) a front panel;
(b) a rear panel;
(c) a latch arm;
(d) a circular extension; and
(e) a circular rotating cuff;
wherein the rear panel is comprises a top portion and a bottom portion, and wherein the top and bottom portions of the rear panel are fixedly attached to the front panel;
wherein the rear panel further comprises a middle portion, and wherein the latch arm is situated in between the front panel and the middle portion of the rear panel;
wherein the circular extension extends perpendicularly from the front panel and is fixedly attached to the latch arm through a cut-out in the front panel;
wherein the circular rotating cuff is located in a cut-out in the middle portion of the rear panel and is fixedly attached to the latch arm;
wherein the circular extension and circular rotating cuff each comprises a wrench hole;
wherein when a wrench is inserted into the wrench hole, the latch arm can be rotated ninety degrees to the left or ninety degrees to the right from a filly retracted position;
wherein the latch comprises a right side and a left side, and the right and left sides of the latch each comprises a latch stop that prevents the latch arm from extending greater than ninety degrees from a fully retracted position;
wherein when the latch arm is in a fully retracted position, it is situated completely between the front panel and the middle portion of the rear panel;
wherein the wrench hole in the circular extension does not extend all the way through the latch;
wherein the wrench hole in the circular rotating cuff does not extend all the way through the latch;
wherein the wrench hole in the circular extension and the wrench hole in the circular rotating cuff are aligned laterally; and
wherein the circular extension comprises one or more O-rings.

2. The latch of claim 1, wherein the latch is installed on a chassis of a display module,
wherein the chassis comprises a front face, a rear face, and a latch hole;
wherein the latch hole extends from the front face to the rear face of the chassis;
wherein the circular extension is inserted into the latch hole from the rear face of the chassis;
and wherein the O-rings on the circular extension prevent water from traveling through the latch hole from the front to the rear of the display module.

3. The latch of claim 2, wherein when the display module is installed on a face panel and the latch arm extended, the face panel is situated between the latch arm and the chassis.

4. The latch of claim 3, wherein a rubber gasket is situated between the chassis and the face panel, wherein the rubber gasket comprises compressible lips, and wherein when the latch arm is extended, it draws the chassis in to the face panel, thereby compressing the lips on the rubber gasket.

5. The latch of claim 4, wherein the latch arm comprises beveled edges, and wherein the beveled edges serve to draw the chassis in to the face panel when the latch arm is extended.

6. The latch of claim 1, wherein the circular extension comprises a distal end, wherein the circular extension is roughly ⅞-inch long from the front panel to the distal end of the circular extension, wherein the circular extension comprises a diameter, and wherein the diameter of the circular extension is roughly 0.5-inch.

7. The latch of claim 6, wherein the circular rotating cuff is of roughly the same diameter as the circular extension.

8. The latch of claim 1, wherein the circular rotating cuff comprises cut-outs to reduce the weight of the latch and save material.

9. The latch of claim 1, wherein the front and rear panels each comprises at least two screw holes for attaching the latch to a chassis of a display module.
